(19) United States
(12) Patent Application Publication
(10) Pub. No.: US 2022/0398647 A1
(43) Pub. Date: Dec. 15, 2022

(54) METHODS AND APPARATUSES FOR GENERATING PLANOGRAM

(71) Applicant: ShopperTrak RCT Corporation, Chicago, IL (US)

(72) Inventors: Alfa Zareen HISHAM, Thiruvananthapuram (IN); Jobin JOSE, Pathanamthitta (IN); Saiteja Reddy VENNAPUSA, Madanapalle (IN); Satyanarayan SHANBHAG, Bangalore (IN); Swatilekha KAR, Bhubaneswar (IN)

(21) Appl. No.: 17/347,072

(22) Filed: Jun. 14, 2021

(51) Int. Cl. G06Q 30/06

(52) U.S. Cl. CPC G06Q 30/0639

(57) ABSTRACT

Aspects of the present disclosure include methods, systems, and non-transitory computer readable media for receiving initial planogram data and one or more of traffic data, inventory data, sales data, staff data, or shrink data, wherein the initial planogram data includes initial merchandise placements in a retail store, generating updated planogram data including updated merchandise placements in the retail store, wherein an updated sales revenue associated with the updated merchandise placements is projected to be higher than an initial sales revenue associated with the initial merchandise placements, and providing the updated planogram data.

### BACKGROUND

Placement of merchandise in a retail store may impact the sales of the merchandise. Employees of a retail store may place various merchandise at different locations of the retail store to improve sales. The merchandise placements may be changed routinely based on seasons, holidays, fashion trends, and/or other events. However, employees may be unable to properly optimize merchandise placements. Therefore improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include methods, systems, and/or computer readable media for receiving initial planogram data and one or more of traffic data, inventory data, sales data, staff data, or shrink data, wherein the initial planogram data includes initial merchandise placements in a retail store, generating updated planogram data including updated merchandise placements in the retail store, wherein an updated sales revenue associated with the updated merchandise placements is projected to be higher than an initial sales revenue in accordance with the initial merchandise placements, and outputting the updated planogram data.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for generating a planogram in accordance with aspects of the present disclosure;

FIG. 2 illustrates an example of a technique for producing point of sale data in accordance with aspects of the present disclosure;

FIG. 3 illustrates an example of a technique for producing traffic data in accordance with aspects of the present disclosure;

FIG. 4 illustrates an example of a technique for producing shrink data in accordance with aspects of the present disclosure;

FIG. 5 illustrates an example of a technique for producing planogram data in accordance with aspects of the present disclosure;

FIG. 6 illustrates an example of a method for generating a planogram in accordance with aspects of the present disclosure;

FIG. 7 illustrates an example of a computer system in accordance with aspects of the present disclosure; and

FIG. 8 illustrates an example of a functional diagram for generating a planogram in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

An aspect of the present disclosure may include techniques for generating predictive planogram. Retail stores such as fashion apparels, supermarkets and electronic stores, may depend on the visual display of products and location for increased sales. Retailers may change planogram layouts to boost visibility, which in turn increases the sales. But retailers may lack insights to the effectiveness of their planogram setups. Since planogram changes occur continuously and may not be captured correctly, the retailers may lose sight of optimum placements which were done in the past before being changed. Also, store employees may collate data from different sources to plan for layouts. In some instances, the lack of a predictive planogram tool may be a time consuming process to plan for organized and/or data-backed layout changes within the store.

Some conventional planogram tools fall into the category of being a visual designing software which allows the retail store employees to create layouts and placement plans. However, conventional tools may not have features that allows analysis of data from different sources such as traffic, item location, and past sales data to prescribe an optimum planogram setup for anytime of the year. The conventional tools may lack the means to retrieve the effectiveness of past planograms or distribution of sales associates.

Aspects of the present disclosure includes a solution that may be used in a retail sector, which uses planograms and radio frequency identification (RFID) based inventory solutions to intelligently place products. Some aspects of the present disclosure may include one or more machine learning systems to prescribe an optimum planogram setup for a day, a month, and/or a sales season. The planogram system may be designed to continuously capture changes in store layouts, traffic, point of sales, shrink, staff allocation, and/or prescribe a future layout that may increase sales and reduce costs of staff distribution. Some aspects of the present disclosure may include partially modifying a planogram through movement of blocks. Retailers may rely on revenues from past planogram setups and the effectiveness of store associate distribution to improve sales. Other metrics like location of merchandise, and/or product movement map may be obtained from the system. Such a system may combine RFID based inventory solutions with other metrics to predict and/or prescribe actions to be taken for setting up planogram layouts.

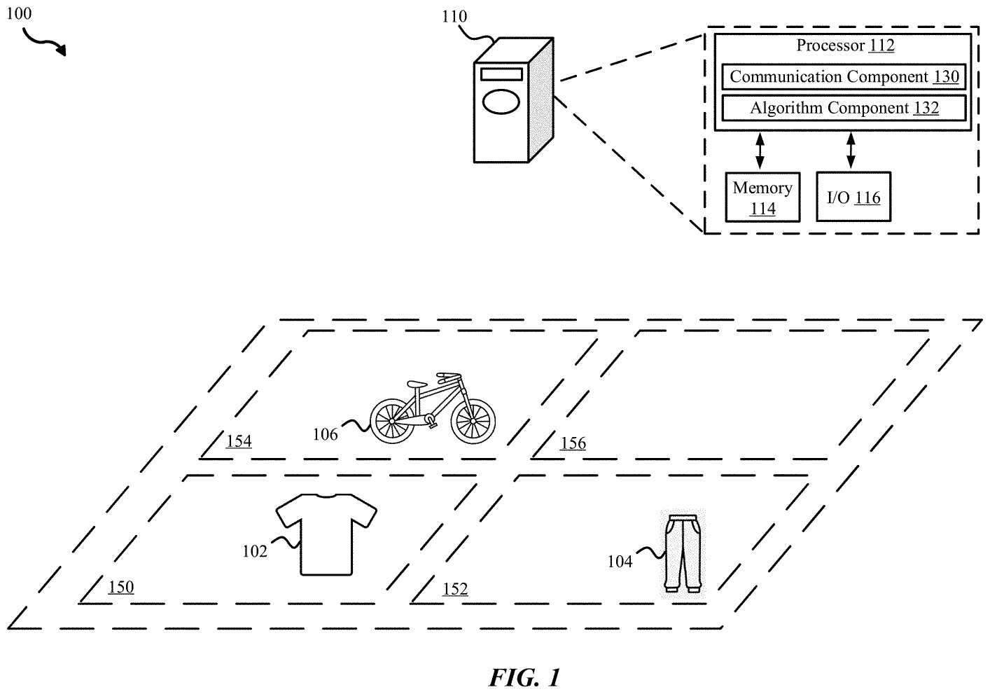

Referring to FIG. 1, in a non-limiting implementation, an example of an environment 100 (e.g., a retail store) is shown. The environment 100 may include a first merchandise 102, a second merchandise 104, and/or a third merchandise 106. The environment 100 may include a planogram system 110 for generating one or more planograms including merchandise placements in the environment 100. The environment 100 may include a first block 150, a second block 152, a third block 154, and/or a fourth block 156. The first block 150, second block 152, third block 154, and fourth blocks 156 may be shelf spaces, floor spaces, wall spaces, and/or other spaces in the retail store. Although four blocks are shown in the present example, more or less blocks may be allocated according to aspects of the present disclosure.

In some implementations, the planogram system 110 may be configured to generate one or more planograms of the environment 100. The planogram system 110 may include a processor 112 and a memory 114. The processor 112 may be configured to execute instructions stored in the memory 114 to implement the techniques described in the current application.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In one aspect, the planogram system 110 may include input/output (I/O) 116 configured to receive point of sale (POS) information, staff information, shrink information, traffic information, and/or planogram information. In certain examples, the I/O 116 may include knobs, alpha-numeric keys, buttons, keyboard, touchscreens, or other controls for input. The I/O 116 may include displays or other devices for output. The I/O 116 may include devices and/or interfaces.

In certain aspects, the processor 112 of the planogram system 110 may include one or more components implemented as hardware, software, or a combination thereof. For example, the processor 112 may include a communication component 130 configured to receive planogram data, POS data, shrink data, staff data, and/or traffic data. The processor 112 may include an algorithm component 132 configured to generate updated planogram data. Planogram data may include placement of merchandise in one or more blocks of the environment 100.

During operation, in one implementation, the planogram system 110 may receive one or more of POS data, traffic data, shrink data, staff data, and/or initial planogram data. The POS data may include sales data (e.g., amount of merchandise sold, sales revenues of merchandise, dates and/or times merchandise were sold, predicted POS data, etc.) of the retail store. The traffic data may include customer traffic (e.g., number of customers in each block at a given time, durations of each customer in each block, demographic of customers in each block, predicted traffic data, etc.) in the retail store. The shrink data may include loss of merchandise in the retail store due to theft, accidents, or other causes. The staff data may include work hours, sales made, locations of staff at various times, and/or other information related to staff of the retail store. The initial planogram data may include initial merchandise placements, actual block(s) to be swapped, predicted block(s) to be swapped, and/or other information associated with the retail store.

In some implementations, the planogram system 110 may use the one or more of POS data, traffic data, shrink data, staff data, and/or initial planogram data as training data for one or more machine learning algorithms. The planogram system 110 may use an actual block to be swapped as an input for the machine learning algorithm. The planogram system 110 and/or the algorithm component 132 may execute the machine learning algorithm to output to one or more predictive models. The predictive model may generate a predicted block to be swapped.

In one aspect of the present disclosure, machine learning algorithms may build a model based on training data to make predictions and/or decisions. Based on rewards associated with actions taken given the training data, the machine learning algorithms may be trained to perform certain functions, achieve certain goals, and/or make certain predictions.

For example, the planogram system 110 may receive sales data of the retail store from a previous year, including amount of merchandise sold, times of sales, and/or amount of sales revenue from the sales. The planogram system 110 may receive shrink data, staff data, and/or traffic data. The planogram system 110 may receive initial planogram data. The initial planogram data may indicate that the first merchandise 102 is in the first block 150, the second merchandise 104 is in the second block 152, and the third merchandise 106 is in the third block 154. Based on the receive information, the planogram system 110 may use the one or more machine learning algorithms and/or the one or more predictive models, with at least a portion of the one or more of POS data, traffic data, shrink data, staff data, and/or initial planogram data as input, to generate updated planogram data. The updated planogram data may indicate that the second merchandise 104 should be in the fourth block 156, and the first merchandise 102 and the third merchandise 106 should be in the second block 152.

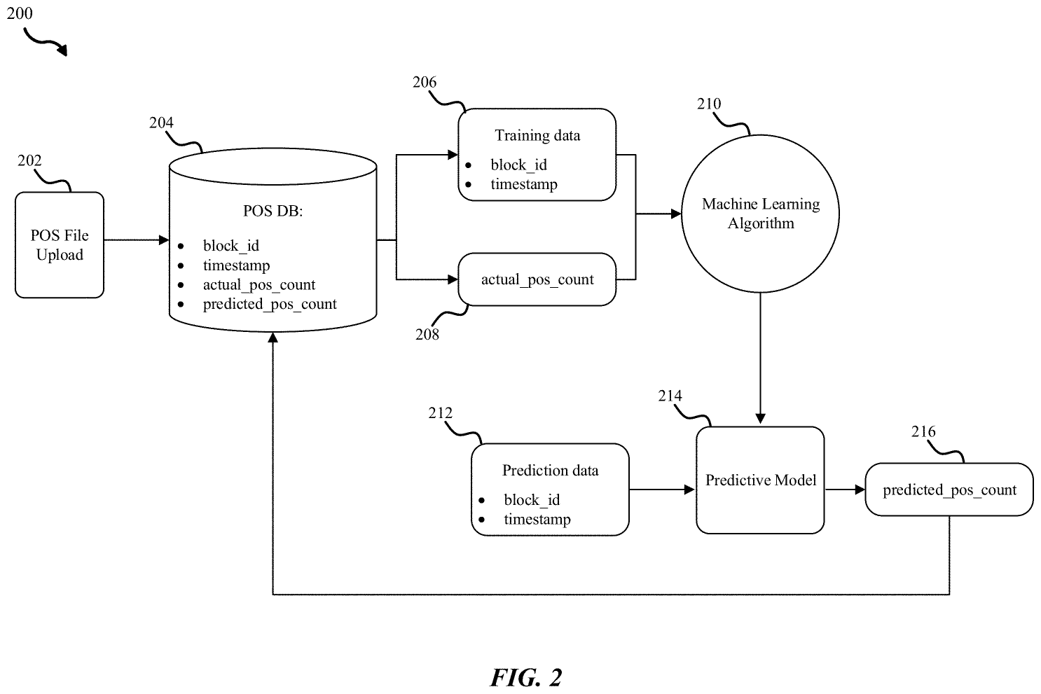

Turning to FIG. 2, an example of a technique 200 for producing POS data. POS files 202 may be uploaded into a POS database (DB) 204. The POS DB 204 may be stored internal in and/or externally from the planogram system 110. Training data 206 (e.g., block ID of the block, timestamp) and an actual POS counts 208 may be provided to one or more machine learning algorithms 210. The output of the one or more machine learning algorithms 210 may be provided to one or more predictive models 214. Prediction data 212 may be provided to the one or more predictive models 214. The predictive model 214 may output a predicted POS count 216, which may be fed back to the POS DB 204.

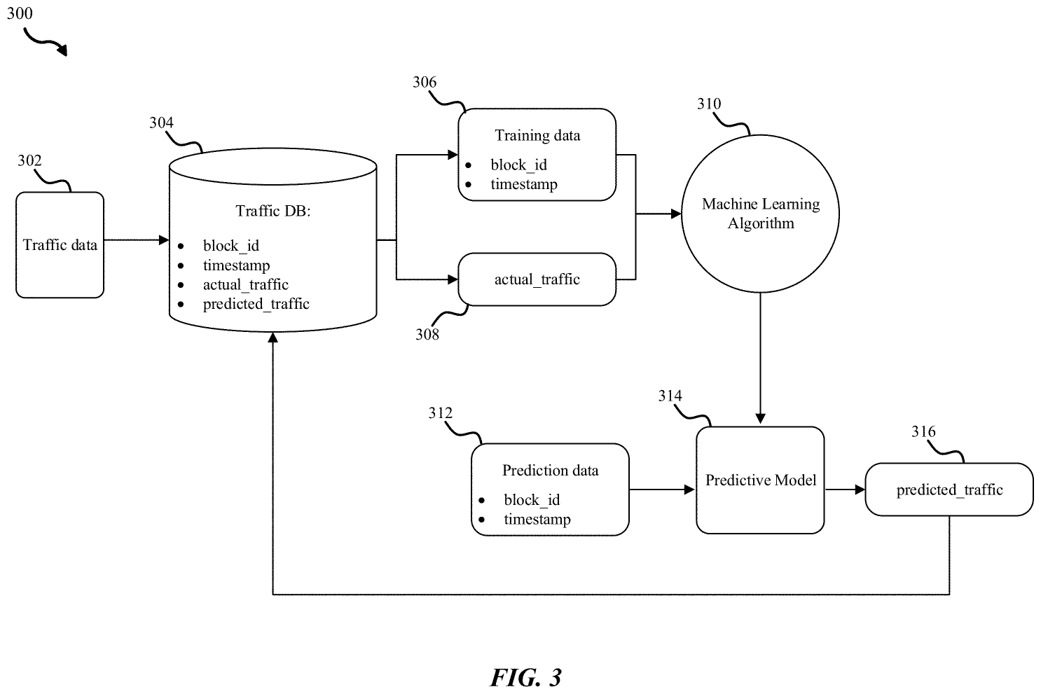

Turning to FIG. 3, an example of a technique 300 for producing traffic data. Traffic data 302 may be uploaded into a traffic DB 304. The traffic DB 304 may be stored internal in and/or externally from the planogram system 110. Training data 306 (e.g., block ID of the block, timestamp) and actual traffic data 308 may be provided to one or more machine learning algorithms 310. The output of the one or more machine learning algorithms 310 may be provided to one or more predictive models 314. Prediction data 312 may be provided to the one or more predictive models 314. The predictive model 314 may output predicted traffic data 316, which may be fed back to the traffic DB 304.

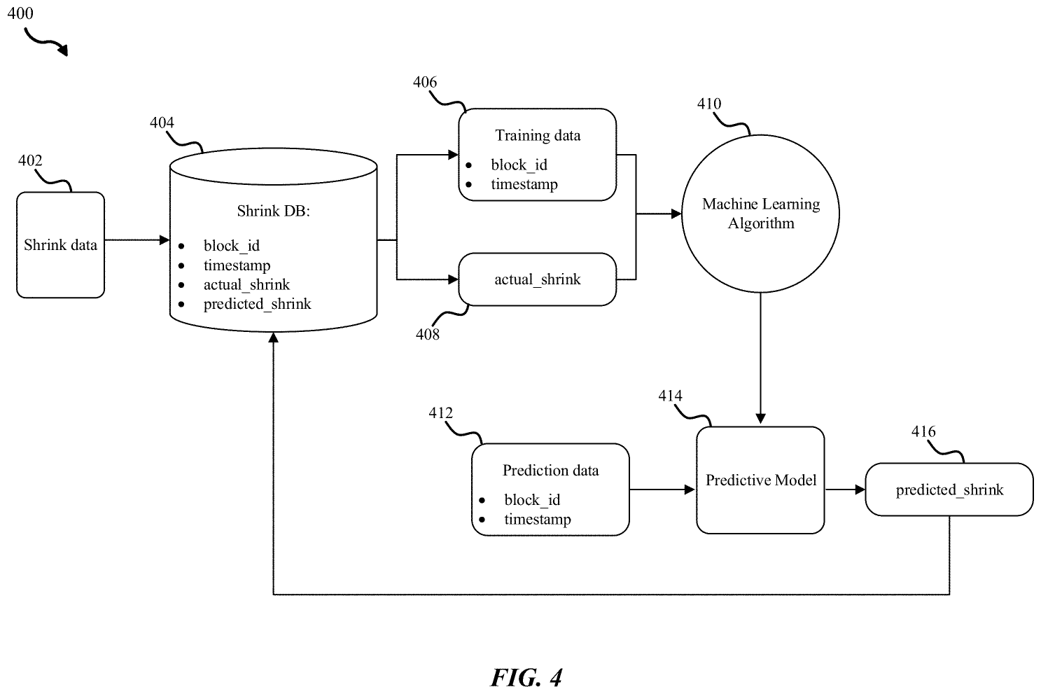

Turning to FIG. 4, an example of a technique 400 for producing shrink data (e.g., losses). Shrink data 402 may be uploaded into a shrink DB 404. The shrink DB 404 may be stored internal in and/or externally from the planogram system 110. Training data 406 (e.g., block ID of the block, timestamp) and actual shrink data 408 may be provided to a machine learning algorithm 410. The output of the machine learning algorithm 410 may be provided to a predictive model 414. Prediction data 412 may be provided to the predictive model 414. The predictive model 414 may output predicted shrink data 416, which may be fed back to the shrink DB 404.

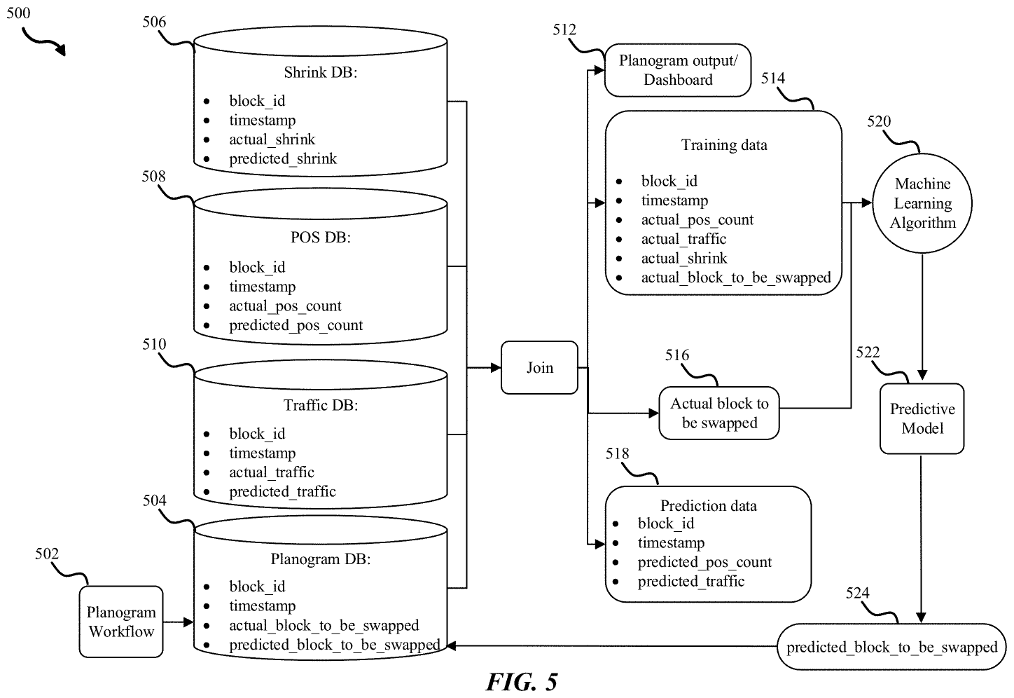

Turning to FIG. 5, an example of a technique 500 for generating planogram data. Planogram workflow 502 may be uploaded into a planogram DB 504. Data from the planogram DB 504, a shrink DB 506, a POS DB 508, and/or a traffic DB 510 may be provided as planogram output/dashboard 512, training data 514, an actual block 516 to be swapped, and/or prediction data 518. In some implementations, the training data 514 and/or the actual block 516 may be provided to a machine learning algorithm 520 as input. The machine learning algorithm 520 may output to a predictive model 522. The predictive model 522 may output a prediction block 524 to be swapped which may be fed back to Planogram DB 504. The technique 500 may be used to generate planogram data such as those described with respect to FIG. 1.

In the example shown in FIG. 5, four DBs may be used to provide training data. Different numbers and/or types of DBs (e.g., POS DB, traffic DB, shrink DB, and/or staff DB) may also be used to provide training data for the machine learning algorithm 520 according to aspects of the present disclosure.

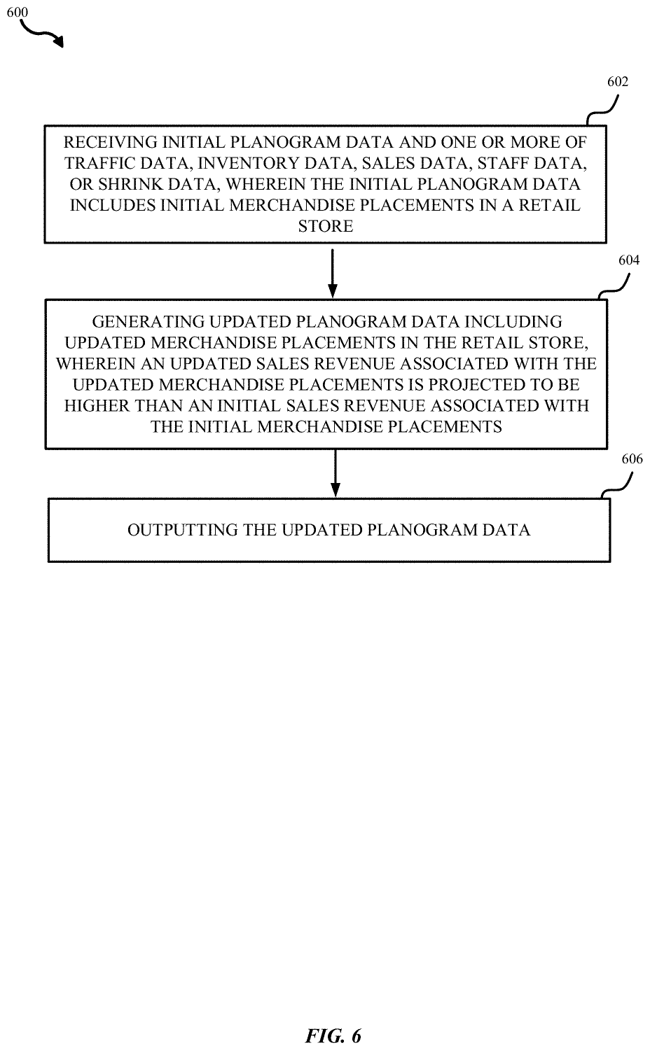

Turning to FIG. 6, an example of a method 600 for generating a planogram. Specifically, the method 600 may be performed by one or more of the processor 112, the communication component 130, the algorithm component 132, the memory 114, and/or the I/O 116 of the planogram system 110.

At block 602, the method 600 may receive initial planogram data and one or more of traffic data, inventory data, sales data, staff data, or shrink data, wherein the initial planogram data includes initial merchandise placements in a retail store. For example, the processor 112, the communication component 130, the memory 114, and/or the I/O 116 of the planogram system 110 may receive initial planogram data and one or more of traffic data, inventory data, sales data, staff data, or shrink data, wherein the initial planogram data includes initial merchandise placements in a retail store as described above. The processor 112, the communication component 130, the memory 114, and/or the I/O 116 of the planogram system 110 may be configured to and/or define means for receiving initial planogram data and one or more of traffic data, inventory data, sales data, staff data, or shrink data, wherein the initial planogram data includes initial merchandise placements in a retail store.

At block 604, the method 600 may generate updated planogram data including updated merchandise placements in the retail store, wherein an updated sales revenue associated with the updated merchandise placements is projected to be higher than an initial sales revenue associated with the initial merchandise placements. For example, the processor 112, the algorithm component 132, the memory 114, and/or the I/O 116 of the planogram system 110 may generate updated planogram data including updated merchandise placements in the retail store, wherein an updated sales revenue associated with the updated merchandise placements is projected to be higher than an initial sales revenue associated with the initial merchandise placements as described above. The processor 112, the algorithm component 132, the memory 114, and/or the I/O 116 of the planogram system 110 may be configured to and/or define means for generating updated planogram data including updated merchandise placements in the retail store, wherein an updated sales revenue associated with the updated merchandise placements is projected to be higher than an initial sales revenue associated with the initial merchandise placements.

At block 606, the method 600 may output the updated planogram data. For example, the processor 112, the communication component 130, the memory 114, and/or the I/O 116 of the planogram system 110 may output the updated planogram data as described above. The processor 112, the communication component 130, the memory 114, and/or the I/O 116 of the planogram system 110 may be configured to and/or define means for outputting the updated planogram data.

In one aspect of the present disclosure, the method 600 may optionally output the updated planogram data to an automated system that rearranges merchandise, furniture, fixtures, models, and/or other items in the retail store. The method 600 may optionally display an updated layout of the retail store.

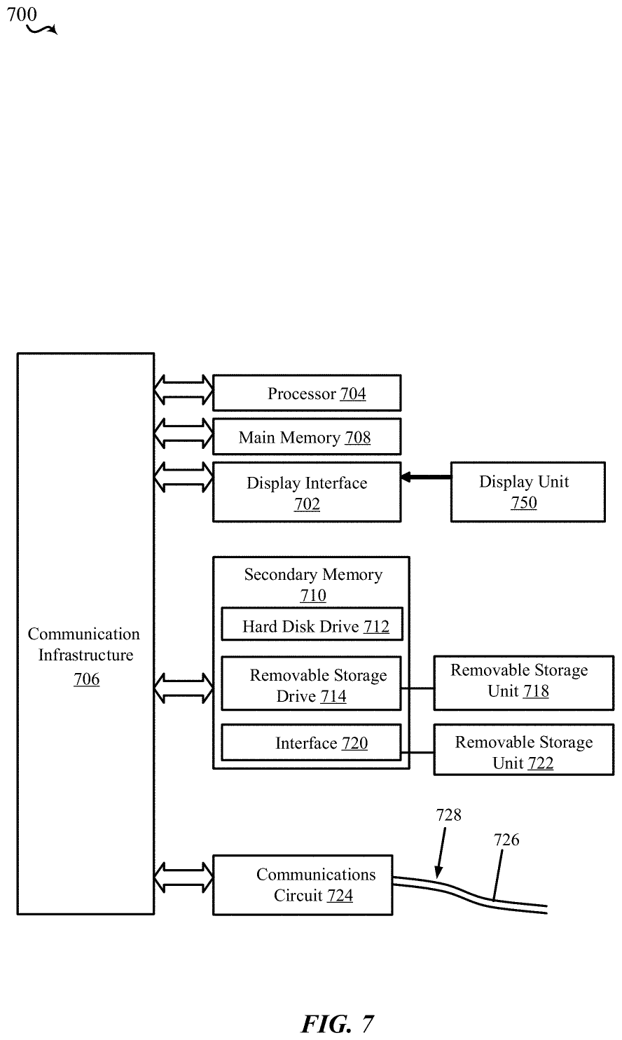

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 700 is shown in FIG. 7. In some examples, the planogram system 110 may be implemented as the computer system 700 shown in FIG. 7. The planogram system 110 may include some or all of the components of the computer system 700.

The computer system 700 includes one or more processors, such as processor 704. The processor 704 is connected with a communication infrastructure 706 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 700 may include a display interface 702 that forwards graphics, text, and other data from the communication infrastructure 706 (or from a frame buffer not shown) for display on a display unit 750. Computer system 700 also includes a main memory 708, preferably random access memory (RAM), and may also include a secondary memory 710. The secondary memory 710 may include, for example, a hard disk drive 712, and/or a removable storage drive 714, representing a floppy disk drive, a magnetic tape drive, an optical disk drive, a universal serial bus (USB) flash drive, etc. The removable storage drive 714 reads from and/or writes to a removable storage unit 718 in a well-known manner. Removable storage unit 718 represents a floppy disk, magnetic tape, optical disk, USB flash drive etc., which is read by and written to removable storage drive 714. As will be appreciated, the removable storage unit 718 includes a computer usable storage medium having stored therein computer software and/or data. In some examples, one or more of the main memory 708, the secondary memory 710, the removable storage unit 718, and/or the removable storage unit 722 may be a non-transitory memory.

Alternative aspects of the present disclosures may include secondary memory 710 and may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and the removable storage unit 722 and the interface 720, which allow software and data to be transferred from the removable storage unit 722 to computer system 700.

Computer system 700 may also include a communications circuit 724. The communications circuit 724 may allow software and data to be transferred between computer system 700 and external devices. Examples of the communications circuit 724 may include a modem, a network interface (such as an Ethernet card), a communications port, a Personal Computer Memory Card International Association (PCMCIA) slot and card, etc. Software and data transferred via the communications circuit 724 are in the form of signals 728, which may be electronic, electromagnetic, optical or other signals capable of being received by the communications circuit 724. These signals 728 are provided to the communications circuit 724 via a communications path (e.g., channel) 726. This path 726 carries signals 728 and may be implemented using wire or cable, fiber optics, a telephone line, a cellular link, an RF link and/or other communications channels. In this document, the terms “computer program medium” and “computer usable medium” are used to refer generally to media such as the removable storage unit 718, a hard disk installed in hard disk drive 712, and signals 728. These computer program products provide software to the computer system 700. Aspects of the present disclosures are directed to such computer program products.

Computer programs (also referred to as computer control logic) are stored in main memory 708 and/or secondary memory 710. Computer programs may also be received via communications circuit 724. Such computer programs, when executed, enable the computer system 700 to perform the features in accordance with aspects of the present disclosures, as discussed herein. In particular, the computer programs, when executed, enable the processor 704 to perform the features in accordance with aspects of the present disclosures. Accordingly, such computer programs represent controllers of the computer system 700.

In an aspect of the present disclosures where the method is implemented using software, the software may be stored in a computer program product and loaded into computer system 700 using removable storage drive 714, hard disk drive 712, or the interface 720. The control logic (software), when executed by the processor 704, causes the processor 704 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

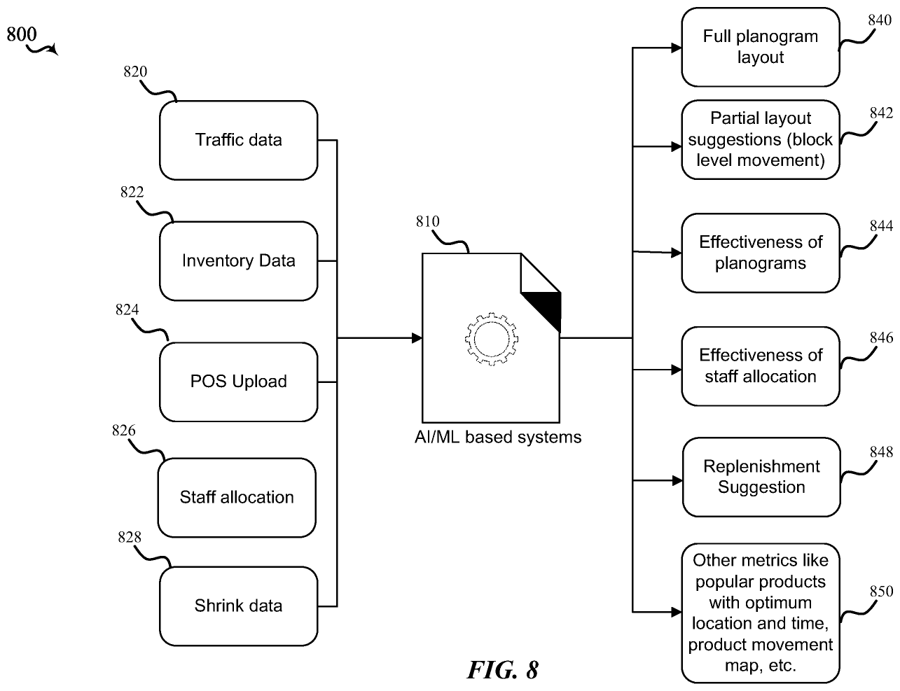

Turning to FIG. 8, a diagram 800 includes one or more artificial intelligence/machine learning (AI/ML) systems 810 that receive one or more inputs relating to a retail store and provide one or more outputs relating to a planogram. In an aspect of the present disclosure, the one or more AI/ML systems 810 may receive traffic data 820, inventory data 822, POS upload information 824, staff allocation information 826, and shrink data 828. The information received by the one or more AI/ML systems 810 may be associated with a retail store. The information may be provided to the one or more AI/ML systems 810 via communication interfaces, graphical user interface devices, or other means.

The one or more AI/ML systems 810 may utility the input information to as training data. The one or more AI/ML systems 810 may output, based on the input information and/or the training process, one or more of a full planogram layout 840 associated with the retail store, a partial layout suggestion 842 (e.g., block level movement), effectiveness of the planograms 844, effectiveness of staff allocation 846, replenishment suggestion 848, and/or other metrics 850 (e.g., like popular products with optimum location and time, product movement map, etc.).

For example, the effectiveness of staff allocation 846 may indicate sales information associated with one or more employees of the retail store. The effectiveness of staff allocation 846 may optionally include recommendation of the placement of the one or more employees of the retail store (e.g., hours, locations, products, etc.). In an example, the information may include a recommendation to place a first employee near a first product and/or a second employee to work during the night shift.

In other examples, the replenishment suggestion 848 may include recommendations to restock certain items in the inventory.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of generating planogram data, comprising:
receiving initial planogram data and one or more of traffic data, inventory data, sales data, staff data, or shrink data, wherein the initial planogram data includes initial merchandise placements in a retail store;
generating updated planogram data including updated merchandise placements in the retail store, wherein an updated sales revenue associated with the updated merchandise placements is projected to be higher than an initial sales revenue associated with the initial merchandise placements; and
outputting the updated planogram data.

2. The method of claim 1, wherein generating the updated planogram data comprises generating the updated planogram data based on providing the initial planogram data and one or more of the traffic data, the inventory data, the sales data, the staff data, or the shrink data to a machine learning algorithm.

3. The method of claim 1, wherein:
the initial planogram data includes a first placement of a merchandise in a first block of a retail store; and
the updated planogram data includes a second placement of the merchandise in a second block of the retail store, wherein the first placement and the second placement are different.

4. The method of claim 3, wherein the first placement or the second placement identifies a shelf, a rack, or a wall of the retail store.

5. The method of claim 1, wherein outputting the updated planogram data comprises outputting the updated planogram data to a planogram database, and the method further comprises generating new planogram data based on updated planogram data and one or more of the traffic data, the inventory data, the sales data, the staff data, or the shrink data.

6. The method of claim 1, wherein generating the updated planogram data comprises applying the initial planogram data and the one or more of traffic data, inventory data, sales data, staff data, or shrink data to a predictive model to generate the updated planogram data.

7. The method of claim 1, wherein:
the initial planogram data includes a first placement of a merchandise in a first block of a retail store during a first period of time; and
the updated planogram data includes a second placement of the merchandise in a second block of the retail store during a second period of time.

8. The method of claim 1, wherein the traffic data includes one or more of a number of customers in each block of the retail store, durations of each customer in each block, demographic information of the customers in each block, or predicted traffic data.

9. The method of claim 1, wherein the sales data includes one or more of a number of merchandise sold, sales revenues generated, sales date of the merchandise, sales times of merchandise, or predicted sales data.

10. The method of claim 1, wherein the staff data includes one or more of work hours of each staff, sales made by each staff, or locations of each staff.

11. A planogram system, comprising:
a memory comprising instructions; and
a processor configured to execute the instructions to:
receive initial planogram data and one or more of traffic data, inventory data, sales data, staff data, or shrink data, wherein the initial planogram data includes initial merchandise placements in a retail store;
generate updated planogram data including updated merchandise placements in the retail store, wherein an updated sales revenue associated with the updated merchandise placements is projected to be higher than an initial sales revenue associated with the initial merchandise placements; and
output the updated planogram data.

12. The planogram system of claim 11, wherein the processor is further configured to generate the updated planogram data based on providing the initial planogram data and one or more of the traffic data, the inventory data, the sales data, the staff data, or the shrink data to a machine learning algorithm.

13. The planogram system of claim 11, wherein:
the initial planogram data includes a first placement of a merchandise in a first block of a retail store; and
the updated planogram data includes a second placement of the merchandise in a second block of the retail store, wherein the first placement and the second placement are different.

14. The planogram system of claim 13, wherein the first placement or the second placement identifies a shelf, a rack, or a wall of the retail store.

15. The planogram system of claim 11, wherein the processor is further configured to:
output the updated planogram data to a planogram database, and
generate new planogram data based on updated planogram data and one or more of the traffic data, the inventory data, the sales data, the staff data, or the shrink data.

16. The planogram system of claim 11, wherein the processor is further configured to apply the initial planogram data and the one or more of traffic data, inventory data, sales data, staff data, or shrink data to a predictive model to generate the updated planogram data.

17. The planogram system of claim 11, wherein:
the initial planogram data includes a first placement of a merchandise in a first block of a retail store during a first period of time; and
the updated planogram data includes a second placement of the merchandise in a second block of the retail store during a second period of time.

18. The planogram system of claim 11, wherein the traffic data includes one or more of a number of customers in each block of the retail store, durations of each customer in each block, demographic information of the customers in each block, or predicted traffic data.

19. The planogram system of claim 11, wherein the sales data includes one or more of a number of merchandise sold, sales revenues generated, sales date of the merchandise, sales times of merchandise, or predicted sales data.

20. The planogram system of claim 11, wherein the staff data includes one or more of work hours of each staff, sales made by each staff, or locations of each staff.

21. A non-transitory computer readable medium including instructions that, when executed by a processor of a planogram system, cause the processor to:
receive initial planogram data and one or more of traffic data, inventory data, sales data, staff data, or shrink data, wherein the initial planogram data includes initial merchandise placements in a retail store;
generate updated planogram data including updated merchandise placements in the retail store, wherein an updated sales revenue associated with the updated merchandise placements is projected to be higher than an initial sales revenue associated with the initial merchandise placements; and
output the updated planogram data.
